(19) United States
(12) Patent Application Publication
(10) Pub. No.: US 2003/0235132 A1
(43) Pub. Date: Dec. 25, 2003

(54) Disk loading apparatus for an optical disk player

(76) Inventors: Hwan-seung Lee, Suwon-city (KR); Young-yun Seol, Seoul (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/445,916

(22) Filed: May 28, 2003

(30) Foreign Application Priority Data
Jun. 22, 2002 (KR) 2002-35121

(51) Int. Cl. G11B 33/02

(52) U.S. Cl. 369/77.1

(57) ABSTRACT

A disk loading apparatus for a disk player, comprising a housing having a turntable disposed inside, a main chassis disposed on top of the housing and onto which a convey roller for conveying a disk is supported, and a slider disposed on a side of the main chassis to move in the loading and unloading directions of the disk. The apparatus further comprises a sub-chassis disposed on the main chassis to reciprocate in a direction transverse to the loading and unloading direction in relation to movement of the slider, and a chucking unit disposed on the main chassis to pivot up and down in relation to movement of the sub-chassis for clamping the disk that has been moved onto a chucking position.

This application claims benefit under 35 U.S.C. §119 from Korean Patent Application No. 2002-35121, filed on Jun. 22, 2002, the entire content of which is incorporated herein by reference.

### BACKGROUND OF THE INVENTION

1. Field of the Invention

The present invention relates to a disk loading apparatus for a disk player, and more particularly, to a disk loading apparatus for a disk player of a motor vehicle that does not have a disk tray.

2. Description of the Related Art

As is well known to those skilled in the art, a disk player is an apparatus for recording information on disks such as a Compact Disk (CD), a CD-ROM, a Digital Video Disk (DVD), and a DVD-ROM, and for playing the recorded information. A disk player typically comprises an apparatus for loading a disk in the position where the information can be recorded or played. A disk inserted into a disk player is loaded on a turntable by a loading apparatus and then clamped by a chucking unit so the disk can be rotated. While the disk is turning, the optical pickup moves in the radial direction of the disk to record information on the disk or play the recorded information.

A motor vehicle disk player, in particular, employs a disk loading apparatus capable of directly loading a disk without a tray due to its limitations in available space. In addition, the motor vehicle disk player uses a loading apparatus for distinctively loading two different sized disks, for example, 80 mm and 120 mm disks.

Examples of such loading apparatuses are disclosed in Korean Patent Application No. 10-2002-32282 entitled “Disk loading apparatus for optical disk player” filed by the present applicant, the entire content of which is incorporated by reference herein. In the disk loading apparatus disclosed in that application, a disk is loaded on the chucking position by a convey roller. The loaded disk pushes disk guide levers to move a cam guider, and then a rack gear of the cam guider meshes with a driving gear. Accordingly, the cam guider moves in a direction opposite to the disk loading direction, and the chucking unit connected to the cam guider is guided by a cam slit formed on the cam guider and clamps the disk positioned on the turntable. Therefore, the disk can rotate on the turntable while being clamped by the damper of the chucking unit.

It is noted that the chucking unit in the above structure is hinged on the left and right sides of the disk loading direction and is moved up and down by the cam guider. However, such a configuration in which the chucking unit is hinged on both the left and right sides of the disk loading direction limits the usable space in the apparatus. That is, since all driving devices for driving a driving motor, a convey roller and a cam guider are disposed at the right side of the disk loading direction, the space for disposing the chucking unit is increased in order to avoid interference between such driving devices and the chucking unit. As a result, the size of the disk player needs to be increased.

In addition, because the chucking unit is connected to be guided by the cam guider, a separate supporting structure should be attached for maintaining the strength of the chucking unit. However, this supporting structure increases the cost and complexity of the overall structure.

### SUMMARY OF THE INVENTION

An object of the present invention is to solve at least the above problems and/or disadvantages and to provide at least the advantages described below.

Accordingly, one object of the present invention is to solve the foregoing problems by providing a disk loading apparatus of a disk player with a simple and improved structure.

The foregoing and other objects and advantages are substantially realized by providing a disk loading apparatus for a disk player comprising a housing having a turntable disposed inside, a main chassis disposed on top of the housing and onto which a convey roller for conveying a disk is supported, and a slider disposed on a side of the main chassis to move in the loading and unloading directions of the disk. The disk loading apparatus further comprises a sub-chassis disposed on the main chassis to reciprocate in cross direction of the loading and unloading direction in association with the slider, and a chucking unit disposed on the main chassis to pivot up and down in relation to movement of the sub-chassis for clamping the disk moved onto a chucking position.

The chucking unit comprises a hinge shaft disposed on the main chassis parallel or substantially parallel to the loading and unloading directions, a pivoting plate with an end hinged on the hinge shaft for pivoting up and down in relation to movement of the sub-chassis, and a damper pivotably disposed at the other end of the pivoting plate for clamping the disk located on the chucking position and rotating together with the turntable.

In addition, a cam slit is formed to step in a sub-chassis movement direction at an end of the sub-chassis, and a cam protrusion is disposed on an edge of the pivoting plate, which is inserted into the cam slit to be guided along the cam slit.

### BRIEF DESCRIPTION OF THE DRAWINGS

The above objects and the features of the present invention will be more apparent by describing an embodiment of the present invention with reference to the accompanying drawings, in which:

FIG. 1 is a plan view schematically showing a disk loading apparatus of a disk player according to an embodiment of the present invention;

FIG. 2 is a side view of the disk loading apparatus of a disk player shown in FIG. 1;

FIG. 3 is a front sectional view of the disk loading apparatus of a disk player shown in FIG. 1; and

FIGS. 4 though 7 are schematic views for illustrating the operation of a disk loading apparatus of a disk player according to an embodiment of the present invention.

### DETAILED DESCRIPTION OF THE PREFERRED EMBODIMENT

A disk loading apparatus of a disk player according to an embodiment of the present invention will be described in greater detail with reference to the accompanying drawings.

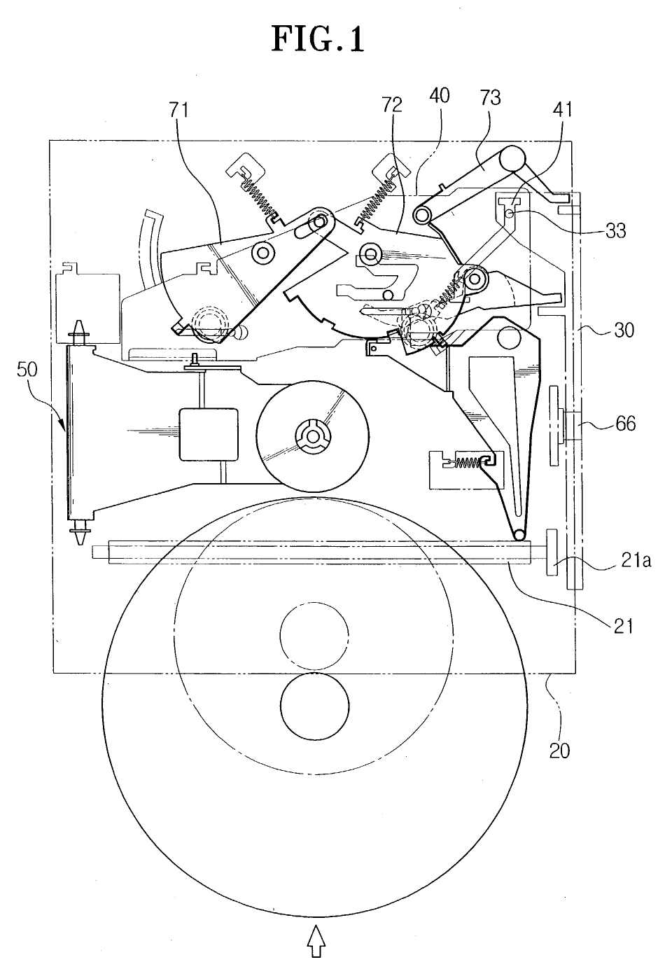

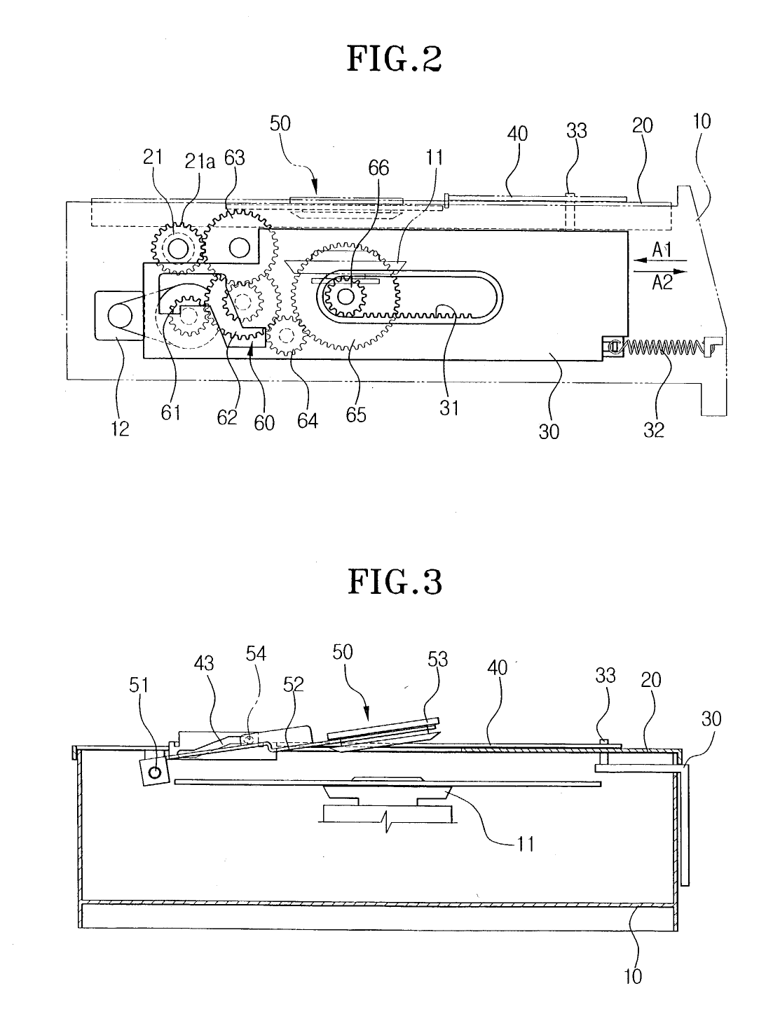

Referring to FIGS. 1 and 2, the disk loading apparatus of the disk player according to an embodiment of the present invention comprises a housing 10 with a turntable 11 disposed inside, a main chassis 20 disposed on the top of the housing 10, and a slider 30 movably disposed at a side of the housing 10 in the loading (A2) and unloading (A1) directions of a disk 1. The disk loading apparatus further comprises a sub-chassis 40 reciprocally disposed on the main chassis 20, and a chucking unit 50 for clamping the disk 1 inserted into the housing 10 and seating the disk 1 on the turntable 11.

Inside the housing 10, the turntable 11 onto which the inserted disk 1 is placed is rotatably supported by a spindle motor (not shown). Also provided in the housing 10 are a driving motor 12 for providing power to a convey roller 21, which will be described later, and to the slider 30, and a power transmission mechanism 60 for transmitting the power of the driving motor 12 to the convey roller 21 and the slider 30. The power transmission mechanism 60 comprises a plurality of connecting gears 61, 62, 63 arranged between the driving motor 12 and a driven gear 21a of the convey roller 21, and other connecting gears 64, 65 for driving the slider 30 by engaging with the connecting gear 62. The driving gear 66 is coaxially connected to the connecting gear 65 and is selectively connected to a rack gear 31 provided in the slider 30.

The slider 30 is disposed on the outer side of the housing 10 to be reciprocated in the A1 and A2 directions. The slider 30 is elastically biased in the A2 direction by a spring 32. The rack gear 31 formed in the slider 30 is selectively connected with the driving gear 66. Accordingly, when the disk 1 is not loaded, the rack gear 31 and the driving gear 66 are separated as shown in FIG. 2. On the contrary, when the disk 1 is loaded, the rack gear 31 and the driving gear 66 become engaged. That is, first and second pivoting plates 71, 72 pivot by the disk 1 being loaded, and the pushing lever 73 that moves along with the second pivoting plate 72 pushes the slider 30 by a determined distance in the A1 direction, thereby engaging the rack gear 31 with the driving gear 66.

In addition, the slider 30 further comprises a cam protrusion 33 for causing the movement of the sub-chassis 40 by its own movement. The cam protrusion 33 extends through the main chassis 20 into the first cam slit 41 formed on the sub-chassis 40.

The sub-chassis 40 is reciprocally disposed on the top of the main chassis 20 in a direction transverse of A1 and A2, that is, in the direction of B1 and B2. The sub-chassis 40 has the first cam slit 41 for receiving the cam protrusion 33. When the cam protrusion 33 moves in the A1 or A2 direction, the sub-chassis 40 moves in the B1 or B2 direction due to the cooperation between the cam slit 41 and the cam protrusion 33.

Referring to FIG. 3, at one side of the sub-chassis 40 is formed a second cam slit 43 stepped in the sub-chassis 40 moving directions. The second cam slit 43 receives a cam protrusion 54 of a chucking unit 50 which will now be described.

As mentioned above, the chucking unit 50 operates to clamp the disk 1 that has been inserted into the housing 10 and placed on the turntable 11, that is, is in the chucking position. The chucking unit 50 is disposed on the main chassis 20 to pivot up and down in cooperation with the sub-chassis 40. The chucking unit 50 comprises a hinge shaft 51 disposed on the main chassis parallel or substantially parallel to the A1 and A2 directions, a pivoting plate 52 with one end hinged on the hinge shaft for moving up and down in engagement with the sub-chassis 40, and a clamper 53 rotatably disposed at the other end of the pivoting plate 52. When the pivoting plate 52 is lowered, the clamper 53 clamps the disk 1 placed on the chucking position, thereby seating the disk 1 on the turntable 11. The clamper 53 rotates together with the disk 1 and the turntable 11.

On an edge of the pivoting plate 52 is provided the cam protrusion 54 inserted into the second cam slit 43. The cam protrusion 54 causes the pivoting plate 52 to move up and down as the cam protrusion 54 is guided by the second cam slit 43 when the sub-chassis 40 moves in the B1 and B2 directions.

The chucking unit 50 according to an embodiment of the present invention can use minimal space as the chucking unit 50 moves in the cross disk 1 convey direction. That is, the chucking unit 50 is positioned in such a manner to avoid interference with the power transmission mechanism 60 as shown in FIG. 2 and with the convey roller 21. Also, the distance in which the chucking unit 50 moves in an up and down direction can be less than in the conventional arrangement.

In addition, since the chucking unit 50 is disposed to move up and down in engagement with the sub-chassis, there is no need for a supporting structure for supporting the chucking unit 50 and therefore, the cost of the apparatus can be reduced.

An example of the operation of the disk loading apparatus for a disk player according to an embodiment of the present invention having the above described structure will now be described.

In the state shown in FIG. 1, the disk 1 is inserted into the housing 10. As shown in FIG. 2, the rack gear 31 and the driving gear 66 of the slider 30 are separated. In addition, the chucking unit 50 is lifted up as shown in FIG. 3. At this state, the disk 1 is further moved to the chucking position by the convey roller 11.

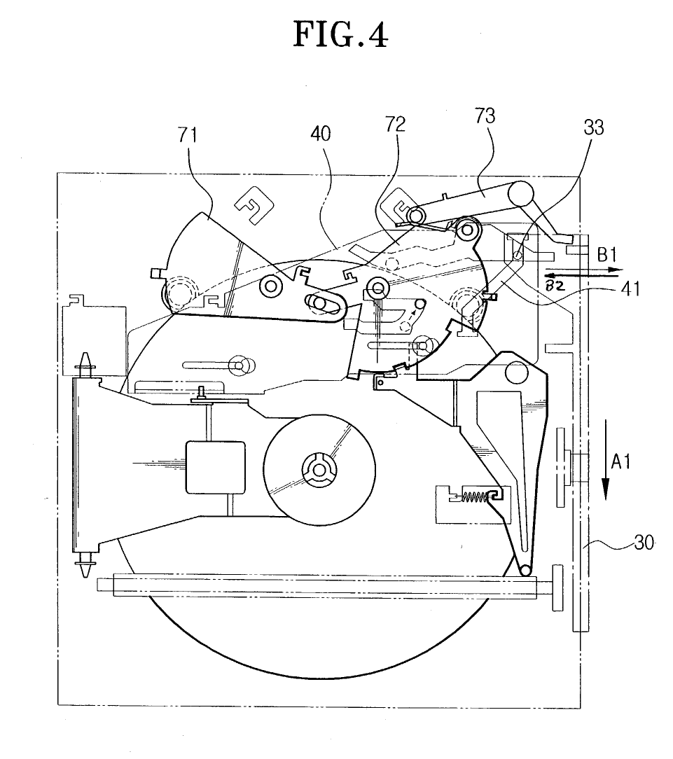

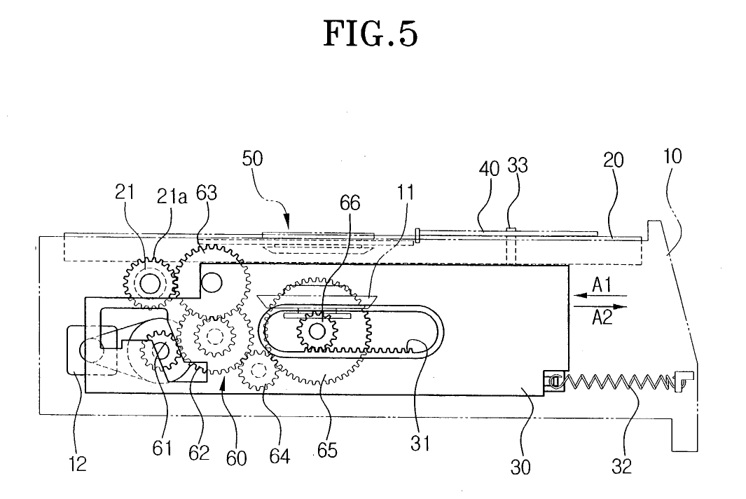

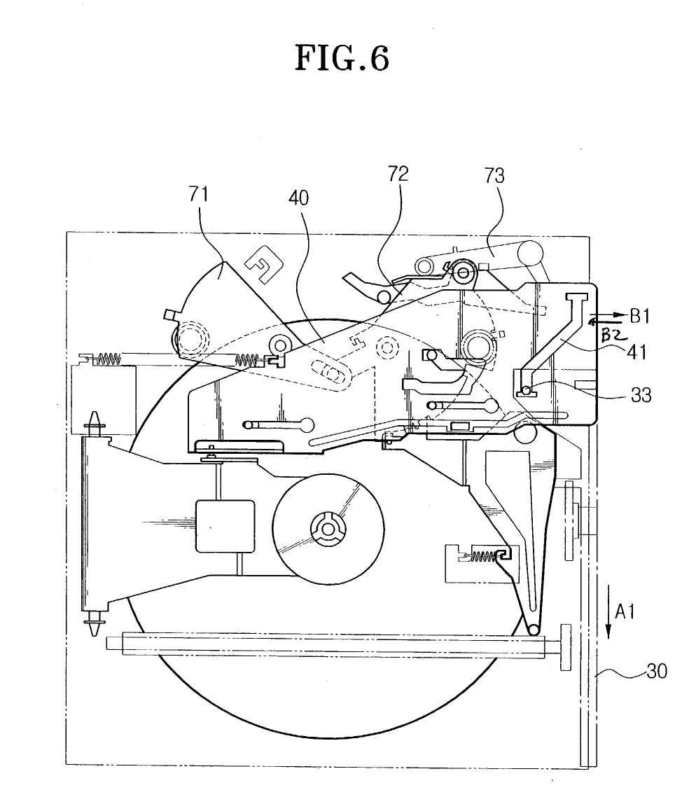

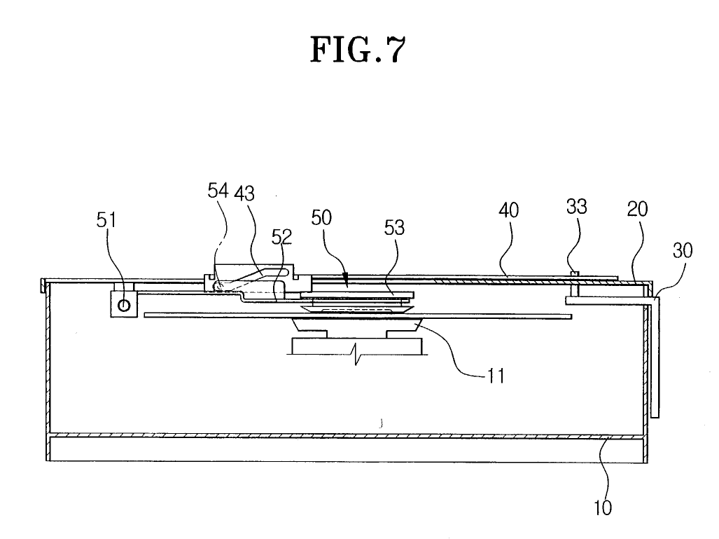

The disk 1 moved to the chucking position pushes and pivots the first and second pivoting plates 71, 72 as shown in FIG. 4. The second pivoting plate 72 then causes the pushing lever 73 to pivot and the pushing lever 73 moves the slider 30 along the A1 direction. Accordingly, the rack gear 31 and the driving gear 66 are engaged as shown in FIG. 5.

From that point, the slider 30 moves along the A1 direction as driven by the power of the driving motor 12. As the slider 30 moves along the A1 direction, the cam protrusion 33 also moves along the A1 direction. Therefore, the sub-chassis 40 is guided along the B1 direction by the movement of the cam protrusion 33 along the first cam slit 41, thereby reaching the state shown in FIG. 6. In other words, when the cam protrusion 33 is located at the lower end of the first cam slit 41, the sub-chassis 40 is at the end of the B1 direction.

Meanwhile, while the sub-chassis 40 moves in the B1 direction, the second cam slit 43 guides the cam protrusion 54, thereby pivoting the chucking unit 50 downwards. When the sub-chassis 40 is completely moved in the B1 direction, the cam protrusion 54 is at the left end of the second cam slit 43 as shown in FIG. 7. The chucking unit 50 is lowered, and the clamper 53 clamps the disk 1 on the turntable 11. At this state, the disk 1 becomes rotatable together with the clamper 53 and the turntable 11.

When the disk 1 is unloaded, the sub-chassis 40 moves in the B2 direction in cooperation with the slider 30 and, in engagement with the sub-chassis 40, the chucking unit pivots upward back to its original position.

According to the disk loading apparatus of a disk player according to the embodiment of the present invention described above, the chucking unit 30 is easy to configure and uses less space since the chucking unit is disposed to pivot up and down in relation to the disk loading direction. Therefore, the size and, in particular, the height of the product can be effectively reduced.

Moreover, because the chucking unit 30 is disposed to move in relation to the movement of the sub-chassis, no separate supporting structure is necessary, thereby reducing the cost of the apparatus.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A disk loading apparatus for a disk player, the apparatus comprising:
a housing having a turntable disposed inside;
a main chassis disposed on top of the housing and onto which a convey roller adapted to convey a disk is supported;
a slider, disposed on the main chassis and adapted to move along loading and unloading directions of the disk;
a sub-chassis, disposed on the main chassis and adapted to reciprocate in cross direction of the loading and unloading direction in relation to movement of the slider; and
a chucking unit, disposed on the main chassis and adapted to pivot up and down in relation to movement of the sub-chassis to clamp the disk that has been moved onto a chucking position.

2. A disk loading apparatus as claimed in claim 1, wherein the chucking unit comprises:
a hinge shaft disposed on the main chassis parallel to the loading and unloading directions;
a pivoting plate having an end hinged on the hinge shaft and adapted to pivot up and down in relation to movement of the sub-chassis; and
a clamper, pivotably disposed at the other end of the pivoting plate and adapted to clamp the disk located on the chucking position and rotate together with the turntable.

3. A disk loading apparatus as claimed in claim 1, wherein:
the sub-chassis includes a cam portion having a cam slit formed therein; and
the pivoting plate includes a cam protrusion which is adapted to be inserted into the cam slit to be guided along the cam slit in accordance with movement of the sub-chassis.

4. A disk loading apparatus as claimed in claim 3, wherein the pivoting plate includes an edge having the cam protrusion extending therefrom.

5. A chucking unit, adapted for use with a disk loading apparatus for a disk player comprising a housing having a turntable disposed therein, a main chassis onto which a convey roller adapted to convey a disk is supported, and a sub-chassis disposed on the main chassis and adapted to reciprocate in cross direction of loading and unloading of the disk, the chucking unit comprising:
a pivoting portion, disposed on the main chassis and adapted to pivot up and down in relation to movement of the sub-chassis to clamp the disk that has been moved onto a chucking position.

6. A chucking unit as claimed in claim 5, further comprising:
a hinge shaft disposed on the main chassis parallel to the loading and unloading directions;
a pivoting plate having an end hinged on the hinge shaft and adapted to pivot up and down in relation to movement of the sub-chassis; and
a clamper, pivotably disposed at the other end of the pivoting plate and adapted to clamp the disk located on the chucking position and rotate together with the turntable.

7. A chucking unit as claimed in claim 5, wherein:
the sub-chassis includes a cam portion having a cam slit formed therein; and
the pivoting plate includes a cam protrusion which is adapted to be inserted into the cam slit to be guided along the cam slit in accordance with movement of the sub-chassis.

8. A chucking unit as claimed in claim 7, wherein the pivoting plate includes an edge having the cam protrusion extending therefrom.
